(19) United States
(12) Patent Application Publication
(10) Pub. No.: US 2008/0183916 A1
(43) Pub. Date: Jul. 31, 2008

(54) Using Extreme Data Rate Memory Commands to Scrub and Refresh Double Data Rate Memory

(76) Inventors: Mark David Bellows, Rochester, MN (US); Paul Allen Ganfield, Rochester, MN (US); Ryan Abel Heckendorf, Rochester, MN (US); John David Irish, Rochester, MN (US); David Alan Norgaard, Rochester, MN (US); Ibrahim Abdel-Rahman Ouda, Rochester, MN (US); Tolga Ozguner, Rochester, MN (US)

Correspondence Address: IBM CORPORATION, INTELLECTUAL PROPERTY LAW, DEPT 917, 3605 HIGHWAY 52 NORTH, ROCHESTER, MN, 55901-7829, US

(21) Appl. No.: 11/668,531

(22) Filed: Jan. 30, 2007

(51) Int. Cl. G06F 13/00

(52) U.S. Cl. 710/33

(57) ABSTRACT

In a first aspect, a first method of interfacing a processor and memory is provided. The first method includes the steps of (1) providing a processor adapted to issue a command complying with a first protocol; (2) providing a memory coupled to the processor and accessible by a command complying with a second protocol; (3) employing a plurality of scrub commands complying with the second protocol to check respective portions of the memory for errors, wherein each scrub command complying with the second protocol is a converted version of a scrub command complying with the first protocol issued by the processor and the respective portions are non-sequential; and (4) refreshing bits stored in the entire memory within a predetermined time period. Numerous other aspects are provided.

### FIELD OF THE INVENTION

The present invention relates generally to computer systems, and more particularly to methods and apparatus for interfacing a processor and a memory.

### BACKGROUND

A first conventional computer system may include a processor coupled to a double data rate (DDR) memory (e.g., SDRAM) via a memory interface, such as a DDR link. DDR memory is cheaper than other memory, such as an extreme data rate (XDR) memory, and/or has a higher storage capacity than such other memory. More specifically, XDR memory is limited in the amount of memory capacity it may support and is more expensive than DDR 2 or DDR 3 memory. The DDR link may be slower than other links (e.g., an extreme input/output (XIO) link). However, a width of the DDR link may be increased (e.g., to 288 bits) to increase a bandwidth thereof. Consequently, the DDR link may consume a large number of processor pins to couple to the processor. By requiring the processor to include a large number of pins, the DDR link may cause an increase in size of the processor and cost associated therewith.

In the first conventional computer system, to avoid losing data stored in a memory, data stored in the DDR memory may be periodically refreshed. All banks of the DDR memory are refreshed by a single command (at the same time). Refreshing all banks of the DDR memory requires more time (e.g., before and after the refreshing) than a refresh of a single memory bank (e.g., of an XDR memory).

A second conventional computer system may include a processor coupled to an extreme data rate (XDR) memory via a memory interface, such as an XIO link. As described above, XDR memory is more expensive and has less storage capacity than DDR memory. However, the XIO link may be a fast, narrow link (e.g., 72 bits wide). Therefore, the XIO link may consume fewer pins on a processor to couple thereto than the DDR link. Consequently, the XIO link may enable a size of the processor and cost associated therewith to be reduced.

In the second conventional system, to avoid losing data stored in a memory, data stored in the XDR memory may be periodically refreshed. Each bank of the XDR memory is refreshed separately. For example, the processor may issue a plurality of commands to refresh respective banks of the XDR memory. Each refresh command may be similar (in timing) to a functional memory command (e.g., a read or write command) and may be inserted into a stream of such commands.

As described above, the DDR link coupled to the processor of the first conventional computer system may cause an increase in the size of the processor and cost associated therewith. Further, the XDR memory included in the second conventional computer system may be more expensive than other memory and may have less storage capacity than such other memory. Accordingly, improved methods, apparatus and systems for interfacing a memory and a processor are desired.

### SUMMARY OF THE INVENTION

In a first aspect of the invention, a first method of interfacing a processor and memory is provided. The first method includes the steps of (1) providing a processor adapted to issue a command complying with a first protocol; (2) providing a memory coupled to the processor and accessible by a command complying with a second protocol; (3) employing a plurality of scrub commands complying with the second protocol to check respective portions of the memory for errors, wherein each scrub command complying with the second protocol is a converted version of a scrub command complying with the first protocol issued by the processor and the respective portions are non-sequential; and (4) refreshing bits stored in the entire memory within a predetermined time period.

In a second aspect of the invention, a first apparatus for interfacing a processor and memory of a computer system is provided. The first apparatus includes (1) a processor adapted to issue a command complying with a first protocol; and (2) a translation chip adapted to couple to the processor and a memory accessible by a command complying with a second protocol. The apparatus is adapted to (a) employ a plurality of scrub commands complying with the second protocol to check respective portions of the memory for errors, wherein each scrub command complying with the second protocol is a version of a scrub command complying with the first protocol issued by the processor that has been converted by the translation chip and the respective portions are non-sequential; and (b) refresh bits stored in the entire memory within a predetermined time period.

In a third aspect of the invention, a first system for interfacing a processor and memory is provided. The first system includes (1) a processor adapted to issue a command complying with a first protocol; (2) a memory accessible by a command complying with a second protocol; and (3) a translation chip adapted to couple to the processor and the memory. The system is adapted to (a) employ a plurality of scrub commands complying with the second protocol to check respective portions of the memory for errors, wherein each scrub command complying with the second protocol is a version of a scrub command complying with the first protocol issued by the processor that has been converted by the translation chip and the respective portions are non-sequential; and (b) refresh data stored in the entire memory within a predetermined time period. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE DRAWINGS

FIG. 1 is a block diagram of a system for interfacing a memory and a processor in accordance with an embodiment of the present invention.

FIG. 2 illustrates a method of interfacing a memory and a processor in accordance with an embodiment of the present invention.

### DETAILED DESCRIPTION

The present invention provides improved methods, apparatus and systems for interfacing a memory and a processor. For example, the present invention may provide a translation chip that couples a processor adapted to issue a command complying with a first protocol to a memory (e.g., a DDR SDRAM) accessible by a command complying with a second protocol of a computer system. More specifically, the computer system may include a first link (e.g., XIO link) that couples the processor to the translation chip. Further, the computer system may include a second link (e.g., a DDR link) that couples the translation chip to the memory. The translation chip may be adapted to convert a command of a first type (e.g., an XDR memory command) issued by the processor to a command of a second type (e.g., a DDR memory command) which may be received by the DDR memory. By coupling an XIO link to the processor, the present methods, apparatus and systems may reduce a size of the processor and cost associated therewith. Further, by employing DDR memory, the present methods, apparatus and systems may employ an inexpensive memory having a high storage capacity (compared to other types of memory).

As described above, to avoid losing data, data stored in the DDR memory should be periodically refreshed. The processor may be adapted to issue a command that complies with XDR command and data protocols to refresh a single bank of memory on the XIO link. However, the DDR memory may only be accessible by a command that complies with DDR command and data protocols in order to refresh all banks of the memory. Therefore, the present invention provides methods and apparatus for converting XDR scrub commands issued by the processor to respective DDR scrub commands which essentially serve to refresh data stored in the memory within a predetermined time period. More specifically, the processor may be adapted to issue a plurality of XDR scrub commands and addresses associated therewith to check respective portions of the memory for errors (e.g., single-bit errors). The translation chip may receive each XDR scrub command and associated address from the processor, convert such command and associated address to a DDR scrub command and associated address and issue the DDR scrub commands on the DDR link. In this manner, the DDR scrub command may check a portion of the memory for an error. More specifically, in response to issuing the DDR scrub command on the DDR link, the translation chip may read targeted data stored in a specific column and row of the DDR memory. To read the data targeted by the command, data stored in the entire row may be read from and then written back into the specified row. Therefore, the command (e.g., the DDR scrub command) to check data stored in the specific row and column of the memory for errors may serve to refresh data stored in the row. Checking non-sequential data stored in the memory for errors in the manner described-above effectively serves to refresh the memory (e.g., all rows thereof) within the predetermined time period.

Once the translation chip receives the targeted data, the translation chip may convert such data so it may be received by the processor and checked for errors, and transmit the converted data to the processor. If the processor detects an error in such data, the processor may correct the data and issue an XDR command to write the corrected data back to the memory. The translation chip may receive such command and convert the XDR write command to a DDR write command that may be employed to access the DDR memory (e.g., to write the corrected data thereto). In this manner, the present invention provides improved methods, apparatus and systems for interfacing a memory and processor. More specifically, the present invention may employ a plurality of scrubs commands that effectively refresh the memory within the predetermined time period. Thus, the present invention may refresh and scrub the memory at the same time.

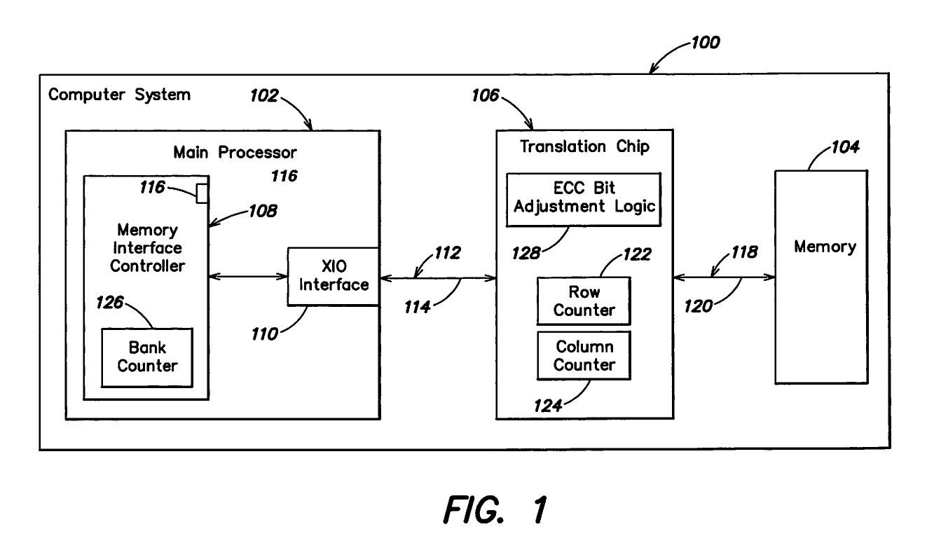

FIG. 1 is a block diagram of a system 100 for interfacing a memory and a processor in accordance with an embodiment of the present invention. With reference to FIG. 1, the system 100 may be a computer or similar device. The system 100 may include a processor 102 coupled to a memory 104 via a translation chip 106. The processor 102 may be adapted to generate and issue functional commands, such as a read, write and/or the like, to the memory 104. For example, the processor 102 may generate a command of a first type (e.g., complying with a first protocol) and associate an address with such command. However, the memory 104 may not be accessible by a command and associated address of the first type, but rather by a command and associated address of a second type (e.g., complying with a second protocol). Therefore, the translation chip 106 may be adapted to receive a command and associated address of the first type, translate such command and address to a command and associated address of the second type. Further, the translation chip 106 may forward the command and associated address of the second type to the memory 104.

More specifically, the processor 102 may include and/or be coupled to a memory interface controller (MIC) 108 adapted to control the flow of data to and from the memory 104. The MIC 108 may be coupled to a memory interface 110 through which data may be transmitted from and received by the processor 102. The memory interface 110 may be included in and/or coupled to the processor 102. The memory interface 110 may be an extreme input/output (XIO) interface. Typically, a processor employs an XIO interface to couple directly to an XDR memory, architected by Rambus, Inc. of Los Altos, Calif. Therefore, the commands and addresses of the first type generated by the processor 102 may be XDR commands and addresses. However, XDR memory is expensive and has less storage capacity than other memories. Consequently, the present system 100 may employ a different type of memory 104. For example, the memory 104 may be a double data rate (DDR) memory (e.g., a DDR 2 or DDR 3 memory), which may be less expensive and have more storage capacity than XDR memory.

However, the memory interface 110 may not be adapted to couple directly to the DDR memory 104. For example, the memory interface 110 may be adapted to transmit a command of the first type (e.g., an XDR command) on the first link 112, and as stated above, the memory 104 may only be accessible by a command of the second type (e.g., a DDR command). Therefore, the memory interface 110 may be coupled, via the first link 112, to the translation chip 106, which may translate a command of a first type received from the processor 102 to a command of a different type which may be employed to access the memory 104. The first link 112 may be a narrow, fast link such as an XIO link. An XIO link may provide high bandwidth to memory by enabling eight bits of data to be sent on each of a plurality of lines in the link per clock cycle from the MIC 108 to the translation chip 106. Consequently, the XIO link may be capable of achieving signal rates of at least 3.2 Gbps, which may allow the MIC 108 and/or processor 102 coupled thereto to use fewer I/O, and therefore, save on die size and cost. More specifically, in some embodiments, the first link 112 may include a 72-bit bus 114. However, the bus 114 may be wider or narrower. Further, the first link 112 may include a larger number of and/or different types of buses. The bus 114 may be adapted to transmit read, write, refresh and/or similar commands thereon. Because the first link 112 is fast and narrow, a reduced number of processor pins 116 may be required to couple to the link 112. For example, seventy-two processor pins 116 may be required to couple to the bus 114 (although a larger or smaller number of pins may be required). Consequently, an overall number of pins 116 included in the processor 102 may be reduced (compared to the number of pins required to couple to a different type of link). Therefore, a size of the processor 102 and cost associated therewith may be reduced.

Thus, the translation chip 106 may couple to a processor 102, which executes an application requiring access to a large amount of memory, via an XIO interface and XIO link. The translation chip 106 may receive XDR command and data protocols and convert such command and data protocols to DDR 2 or DDR 3 command and data protocols. By coupling an XIO link to a DDR memory, the translation logic 106 provides the system 100 with the advantage of using the XIO link (e.g., fewer pins consumed on an expensive processor 102) and the advantage of using DDR memory (e.g., lower cost and higher storage capacity than other memories).

As stated, the translation chip 106 may receive the command and associated address of the first type from the processor 102 via the first link 112 and convert such command and associated address to a command and associated address of the second type. The differences between commands of the first and second types may cause the commands to require special handling by the translation chip 106. Further, the translation chip 106 may be coupled to the memory 104 via a second link 118. The second link 118 may be a link that is slower than the first, such as a DDR link. However, the second link 118 may be wider than the first link 112 (e.g., so the bandwidth of the second link 118 matches that of the first). For example, the second link 118 may include a 288-bit bus 120. However, the bus 120 may be wider or narrower as long as the second link 118 is wider than the first link 112. Further, the second link 118 may include a larger or smaller number of and/or different types of buses. The bus 120 may be adapted to transmit commands of the second type and an address and/or data associated therewith on the second link 118 for the memory 104. Therefore, the translation chip 106 may be adapted to receive data bits from a 72-bit bus 114 and transmit the data bits on a 288-bit bus 120. In this manner, the system 100 may employ the narrow, fast first link 112 to reduce a size and/or cost associated with the processor 102 coupled thereto. Further, the system 100 may employ an inexpensive memory 104 having a large storage capacity.

To avoid losing data (e.g., bits) stored in the memory 104, data stored in the memory 104 should be periodically refreshed. For example, data stored in all rows of the memory 104 should be refreshed within a predetermined time period. The processor 102 may be adapted to issue a memory refresh command that complies with a first protocol (e.g., XDR protocol). However, the memory 104 should only be accessed by a memory refresh command that complies with a second protocol (e.g., DDR protocol). A memory refresh command that complies with the first protocol may be very different than the memory refresh command that complies with the second protocol. For example, DDR command to refresh all memory banks may require more time than an XDR command to refresh a single memory bank. The processor 104 may not include a gap between refresh commands to accommodate the extra time required to perform the DDR refresh command. Therefore, converting a memory refresh complying with the first protocol issued by the processor 102 to a memory refresh command complying with the second protocol to access the memory may be complex. Consequently, rather than generating a memory refresh command complying with a first protocol, converting such command to a memory refresh command complying with a second protocol and employing the command complying with the second protocol to access the memory 104, the present system 100 may employ a plurality of memory scrub read commands that effectively serve to refresh the memory 104. Thus, a memory scrub read command may be “converted” into a memory refresh command. In this manner, the system 100 may be adapted to refresh data stored in the memory 104 while checking data stored in the memory 104 for errors. To wit, the system 100 may be adapted to refresh data stored in the entire memory 104 while scrubbing the memory 104 (e.g., checking and possibly correcting portions of the memory 104 for single-bit errors to prevent them from turning into double-bit errors). Each command generated by the processor 102 may include an address targeted by the command and/or error correction code (ECC) bits which may be employed to ensure data included in the command does not include errors. The address may include a scrub bit S, which indicates whether the command is a memory scrub command. As described below, if the scrub bit S of a command indicates or signals the command is a memory scrub command, remaining portions of the address may be an arbitrary address (e.g., an “out of range” address). Further, such command may actually target an address different than that included in the command.

More specifically, the processor 102 (e.g., MIC 108 included therein) may be adapted to generate a plurality of memory scrub read commands that comply with the first protocol (e.g., XDR protocol) and transmit such commands on the first link 112 via the memory interface 110. The translation chip 106 may be adapted to receive such commands, convert them to respective memory scrub commands that comply with the second protocol (e.g., DDR protocol) and transmit such converted commands on the second link 118 so that such converted memory scrub commands may be performed on the memory 104.

For example, the processor 108 may generate a first memory scrub command that complies with the first command protocol. The first memory scrub command may include an address and initial ECC bits. The initial ECC bits may be logic “0”s. The address may include the scrub bit S. The processor 102 may issue such command including an out of range address on the first link 112 via the memory interface 110 to the translation chip 106. Upon receiving the first command complying with the first protocol, the translation chip 106 may convert the first memory scrub command that complies with the first protocol to a first memory scrub command that complies with the second protocol. The scrub bit S and/or out of range address of the command received by the translation chip 106 may indicate the command is a memory scrub command. For each memory scrub command received by the translation chip 106, the translation chip 106 may detect the scrub bit S and/or out of range address and form a new memory scrub command to be issued on the second link 118 which includes an address different than that included in the received command. For example, in response to receiving the first command, which includes an address and ECC bits, complying with the first protocol, the translation chip 106 may form a first command complying with the second protocol that includes a target address different than that included in the received command.

The translation chip 106 may include and/or be coupled to logic that stores the address targeted by a memory scrub command created by the translation chip 106. For example, the translation chip 106 may include a first counter 122 to store data indicating a row targeted by the memory scrub command created by the translation chip 106 and a second counter 124 to store data indicating a column targeted by the memory scrub command created by the translation chip 106. Further, the MIC 108 may indicate a third counter 126 that may indicate a bank targeted by such memory scrub command. Thus, such counters 122, 124, 126 may store the next address of the memory 104 to be scrubbed. As memory scrub commands are issued to addresses stored by the counters 122, 124, 126, the value stored in the first counter 122 indicating a row may be incremented until such count wraps around. Then, the value stored in the second counter 124 indicating a column may be incremented. Thereafter, the value stored in the first counter 122 may be incremented again until the count wraps. In this manner, memory scrub commands to an address stored in the counters may serve to refresh all rows of the memory 104 within a predetermined time period.

The translation chip 106 may issue the first memory scrub command complying with the second protocol on the second link 118 such that the command may be performed on the memory 104. The system 100 may access bits stored in a memory location (e.g., a specific bank, row and column) targeted by the address included in the first memory scrub command of the second protocol. To access such bits, the system 100 may read bits stored in the entire targeted row. The bits stored in the targeted memory location may be outputted from the memory 104 and received by the translation chip 106 via the second link 118. Such bits may include one or more data bits and one or more ECC bits associated therewith. In some embodiments, the bits may include address parity bits which may ensure the processor 102 is configured to correctly access bits from the memory 104. The ECC bits may be formed by performing an error correction algorithm on at least the data bits (e.g., when the data was stored in the memory 104).

As described above, the first command complying with the first protocol may target a different memory address than the first command complying with the second protocol. More specifically, the address of the out of range address may not be the same as the scrub address maintained in the bank, row and column counters 122, 124, 126 and counts (previous counter values stored by the translation chip 106). To accommodate for the difference between the addresses targeted by such commands of the first and second protocols, the translation chip 106 may adjust ECC bits associated with a command of the first and/or second protocols. More specifically, the translation chip 106 may include and/or be coupled to ECC bit adjustment logic 128 adapted to perform the above-described adjustment. Further, the translation chip 106 may be adapted to adjust parity bits, if necessary, associated with an address included in a command complying with the first and/or second protocol.

For example, the translation chip 106 may be adapted to update the address parity associated with the address stored by the system logic (e.g., the first through third counters 122, 124, 126) to accommodate for the difference between the addresses targeted by the command of the first protocol and the command of the second protocol. Such updated parity bits may be included in the command of the second protocol to access the bits from the targeted memory address. Further, after the translation chip 106 receives the bits from the memory 104, the ECC bit adjustment logic 128 may adjust the ECC bits included therein to accommodate for the difference between the addresses targeted by the command of the first protocol and the command of the second protocol. The translation chip 106 may forward the bits received from the memory 104 to the processor 102 via the first link 112. However, the translation chip 106 may replace the ECC bits received from the memory 104 with updated ECC bits created by the ECC bit adjustments logic 128.

The processor 102 may receive such bits via the first link 112 and determine whether the bits include errors. For example, the MIC 108 may execute ECC to detect and correct an error (e.g., a single-bit error) in the bits. As part of the memory scrub operation, if the MIC 108 detects and corrects an error in the bits received from the translation chip 106, the MIC 108 may issue a second command complying with the first protocol, which may target the same address as the first scrub command complying with the first protocol, on the first link 112. The second command may be a command to write the corrected bits formed by the MIC 108 back to the memory 104. The corrected bits may include ECC bits resulting from the ECC algorithm performed on a portion (e.g., data bits) of the corrected bits.

The translation chip 106 may receive the second command complying with the first protocol and convert such command to a second command complying with the second protocol. The second command may target the same address as that of the first scrub command complying with the second protocol. Additionally, to accommodate for the difference between the addresses targeted by the second command complying with the first protocol and the second command complying with the second protocol, the translation chip 106 may adjust ECC bits associated with the second command complying with the first protocol to form the ECC bits included in the second command complying with the second protocol. Further, the translation chip 106 may update parity bits included in the second command complying with the first protocol to updated parity bits which may be included in the second command complying with the second protocol.

The translation chip 106 may issue such second command complying with the second protocol on the second link 118 such that the corrected data bits and the updated ECC bits included in the second command complying with the second protocol are written back to the memory location targeted by such command. In this manner, a first portion of the memory 104 may be checked for an error. Further, as described above, while checking the first portion of the memory 104 for an error, data in a target bank, row and/or column specified by the first scrub command complying with the second protocol may be read from the memory 104. To read the data targeted by such command, data stored in the entire row of memory 104 may be read from and then written back into the specified row. In this manner, the data stored in such row may be refreshed. Therefore, while checking data stored in a specific row and column of the memory for errors (as part of a memory scrub command) the system 100 may refresh data stored in the row. By checking non-sequential data stored in the memory for errors in the manner described-above, the system 100 may effectively refresh the memory 104 (e.g., all rows thereof) within the predetermined time period.

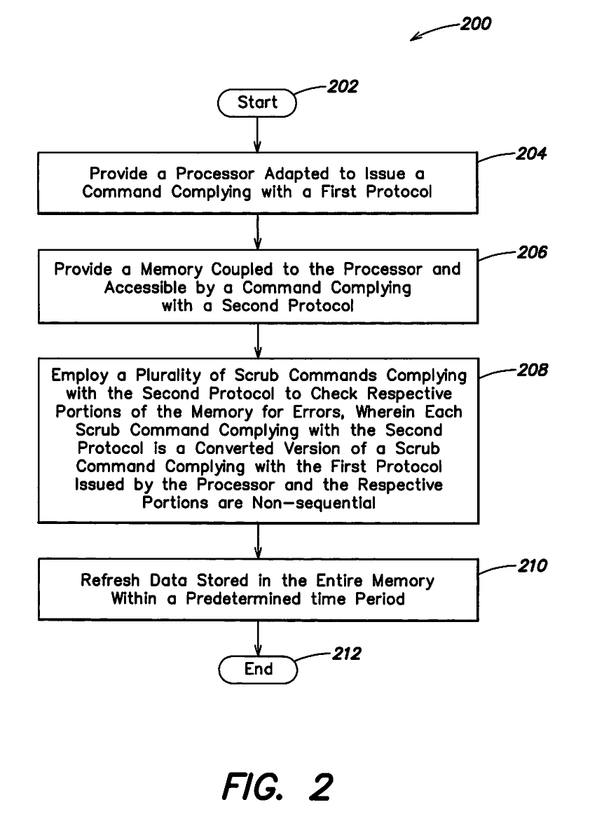

FIG. 2 illustrates a method 200 of interfacing a memory 104 and a processor 102 in accordance with an embodiment of the present invention. With reference to FIG. 2, in step 202, the method 200 begins. In step 204, a processor 102 adapted to issue a command complying with a first protocol may be provided. As described above, the system 100 may include a processor 102 coupled to a first link 112, which may reduce a size and/or cost associated with the processor 102 coupled thereto. The processor 102 may include a MIC 108 and a memory interface 110 coupled thereto. The MIC 108 may create the command complying with the first protocol and issue such command on the first link 112 via the memory interface 110. In this manner, such command may be received by a translation chip 106 coupled to the first link 112. The first protocol may be extreme data rate (XDR) protocol, and therefore, the memory interface may be an extreme input/output (XIO) memory interface and the first link 112 may be an XIO link. However, the first protocol may be a different protocol, and therefore, a different type of memory interface 110 and/or first link 112 may be employed.

In step 206, a memory 104 coupled to the processor 102 and accessible by a command complying with a second protocol may be provided. As described above, the system 100 may include a memory 104 that may be more inexpensive than and/or have a larger storage capacity than other types of memory 104. Such memory 104 may be accessible by a command complying with the second protocol. The memory 104 may be coupled to the translation chip 106 via a second link 118 adapted to transmit a command complying with the second protocol. The second protocol may be a double data rate (DDR) protocol, and therefore, the second link 118 may be a DDR link. However, the second protocol may be a different protocol, and therefore, the second link 118 may be a different type of link.

In step 208, a plurality of scrub commands complying with the second protocol may be employed to check respective portions of the memory 104 for errors. Each scrub command complying with the second protocol may be a converted version of a scrub command complying with the first protocol issued by the processor 102. Further, the respective portions of the memory 104 may be non-sequential. For example, as described above, the MIC 108 may create a first memory scrub command complying with the first protocol, and issue such command on the first link 112. The translation chip 106 may receive such memory scrub command complying with the first protocol via the first link 112. The translation chip 106 may convert such first memory scrub command complying with the first protocol to a memory scrub command complying with the second protocol in the manner described above. The translation chip 106 may issue the first scrub command complying with the second protocol on the second link 118 such that the memory scrub operation may be performed on the memory 104.

As part of the first memory scrub operation, bits stored in a first portion of the memory 104 (e.g., a first targeted row and column) may be read therefrom and transmitted to the translation chip 106 via the second link 118. ECC bits included in the bits read from the first portion of the memory 104 may be adjusted (if the address is included in the ECC calculation) to accommodate for the difference in addresses targeted by the first memory scrub command complying with the first protocol and the first memory scrub command complying with the second protocol. In this manner, the address being scrubbed may include the correct ECC bits. The updated bits may be transmitted to the processor 102 via the first link 112. The MIC 108 may receive such updated bits and check the bits for an error (e.g., a single bit error). The MIC 108 may employ an error checking algorithm to check the bits for an error. If the MIC 108 does not find an error in the bits, no action is taken. Alternatively, if the MIC 108 does find an error in the bits, the MIC 108 may execute ECC to correct the error. The MIC 108 may issue a command complying with the first protocol on the first link 112 to write the corrected bits back to the memory 104. The address included in such write command may be the same as that (e.g., the “out of range” address) included in the first memory scrub command complying with the first protocol. If the system 100 employs the same bank bits (along with the same row and address bits) for a new command as those employed for the initial memory scrub command, the new command is a write operation associated with the memory scrub. Alternatively, if the system 100 employs different bank bits for the new command, the new command is a read operation associated with a different memory scrub command. Employing the bank bits to indicate command type may be useful because the command type may not otherwise be known by the time that a decision has to be made whether to increment the column bits in the second counter 124. Previous values stored in the counters 122, 124, 126 may be stored as counts. Such counts may be employed to write bits back to a memory location (e.g., bits corrected as part of a memory scrub). Thus, the scrub operation may be a read request, followed by a write request if an error is detected in the bits read from memory 104.

In either case, the translation chip 106 may receive the command complying with the first protocol to write the bits to be written back to the memory 104. The translation chip 106 may convert such command complying with the first protocol to write the bits to the memory 104 to a command to write the bits to the memory 104 that complies with the second protocol. For example, the translation chip 106 may adjust ECC bits and/or parity bits included in the bits to be written to the memory 104 to accommodate for a difference in addresses targeted by the first write command complying with the first protocol and the first write command complying with the second protocol. If address parity is included in the ECC calculation for the bits, the difference in address may require some ECC bits to change. The translation chip 106 may include the updated ECC bits and/or parity bits in the bits included in the command complying with the second protocol to write back bits to the first portion of the memory 104. In this manner, bits stored in the first portion of the memory 104 may be checked for an error, and if an error is found, the error may be corrected. Further, while checking the first portion of the memory 104 for an error, bits targeted by the first command complying with the second protocol may be read from the memory 104. To read the bits targeted by such command, bits stored in the entire row of memory 104 including the targeted bits may be read from and then written back into the specified row. In this manner, the bits stored in the entire row may be refreshed.

The system 100 may employ one or more additional memory scrub commands to check different portions of the memory 104 for errors. A different portion of the memory may be non-sequential with a portion of the memory 104 that was previously scrubbed. In this manner, all bits stored in a different row of the memory 104 may be refreshed. However, the different portion may not be required to be non-sequential with the portion of the memory 104 that was previously scrubbed.

For example, the MIC 108 may create a second memory scrub command complying with the first protocol that targets a second portion of memory that is non-sequential with the first portion of the memory 104 that was previously scrubbed. Such command may be issued on the first link 112. The translation chip 106 may receive such second memory scrub command complying with the first protocol via the first link 112. The translation chip 106 may convert such second memory scrub command complying with the first protocol to a second memory scrub command complying with the second protocol in a manner similar to that described above. The translation chip 106 may issue the second memory scrub command complying with the second protocol on the second link 118 such that the memory scrub operation may be performed on the second portion of the memory 104. As part of the second memory scrub operation, bits stored in a second portion of the memory 104 (e.g., a second targeted row and column) may be read therefrom and transmitted to the translation chip 106 via the second link 118. ECC bits included in the bits read from the second portion of the memory 104 may be adjusted to accommodate for the difference in addresses targeted by the second memory scrub command complying with the first protocol and the second memory scrub command complying with the second protocol. The updated bits may be transmitted to the processor 102 via the first link 112. The MIC 108 may receive such updated bits and check the bits for an error. The MIC 108 may employ an error checking algorithm to check the bits for an error. If the MIC 108 does not find an error in the bits, no action is taken. Alternatively, if the MIC 108 does find an error in the bits, the MIC 108 may execute ECC to correct the error and create corrected bits. The MIC 108 may issue a command complying with the first protocol on the first link 112 to write the corrected bits back to the second portion of the memory 104. The address included in such write command may be the same as that of the second memory scrub command complying with the first protocol.

In either case, the translation chip 106 may receive the command complying with the first protocol to write the bits back to the memory 104. The translation chip 106 may convert such command complying with the first protocol to write the bits to the memory 104 to a command to write the bits to the memory 104 that complies with the second protocol. For example, the translation chip 106 may adjust ECC bits (if the address is included in the ECC calculation) and/or parity bits included in the bits to be written to the memory 104 to accommodate for a difference in addresses targeted by the second write command complying with the first protocol and the second write command complying with the second protocol. However, the translation chip 106 may adjust additional and/or different bits during the conversion. The translation chip 106 may include the updated ECC bits and/or parity bits in the bits included in the command complying with the second protocol to write bits to the second portion of the memory 104. In this manner, bits stored in the second portion of the memory 104 may be checked for an error, and if an error is found, the error may be corrected. While checking the second portion of the memory 104 for an error, bits (e.g., in a row and column) targeted by the second command complying with the second protocol may be read from the memory 104. To read the bits targeted by such command, bits stored in the entire memory row including the targeted bits may be read from and then written back into the specified row. In this manner, the bits stored in such row may be refreshed.

In step 210, data stored in the entire memory may be refreshed within a predetermined time period. For example, bits stored in each row of the memory 104 may be refreshed before a predetermined time period. In this manner, the system 100 may ensure bits stored in the memory 104 are not lost. More specifically, as described above, each memory scrub command performed on a portion of the memory 104 may serve to refresh bits stored in a memory row employed (e.g., activated) to access the portion of the memory 104. By performing the memory scrub operations on selected portions (e.g., non-sequential portions) of the memory 104, the system 100 may refresh each row of the memory 104 within the predetermined time period. However, portions of the memory may be scrubbed in any order as long as the entire memory 104 (e.g., all rows included therein) may be refreshed within the predetermined time period. Even after the entire memory 104 is refreshed, the system 100 may continue to scrub remaining portions of the memory 104 until all portions of the memory 104 have been scrubbed.

Thereafter, step 212 may be performed. In step 212, the method 200 ends. Through use of the present method 200, a processor 102 of the system 100 may employ a MIC 108, memory interface 110 and first link 112 adapted to generate and transmit a command of the first type (e.g., an XDR command) to perform an operation on memory 104 accessible by a command of the second type (e.g., a DDR command). Thus, the system 100 may benefit from the advantages of using an XIO link and a DDR memory. Further, the present method may employ scrubbing to refresh the memory 104. More specifically, the present method may employ a plurality of memory scrub commands complying with a first protocol that effectively serve to refresh a memory 104 accessible by commands complying with a second protocol within a predetermined time period. For example, the present method includes conversion of XDR memory scrub commands to DDR memory scrub commands that serve to refresh the memory 104 within a predetermined time period. More specifically, the system 100 may be adapted to employ read requests to “out of range” memory addresses to perform normal refreshes of a respective memory rows. Such requests may also be employed during an all inclusive scrub of the entire memory. The MIC 108 may compare the data returned from the memory 104 with expected data (using an error correction algorithm), correct the data if an error is detected, and issue a command to write the corrected data to the same location from which the data is returned if an error was detected. The system 100 may employ addresses stored in the counters 122, 124, 126 for out of range read operations requested by the MIC 108, respectively. In this manner, the system 100 may cycle through all of the memory addresses and perform a read operation on each such address while scrubbing such address. Consequently, the present invention may perform the refresh and scrub operations at the same time.

The foregoing description discloses only exemplary embodiments of the invention. Modifications of the above disclosed apparatus and methods which fall within the scope of the invention will be readily apparent to those of ordinary skill in the art. For instance, although the translation chip 106 includes the first and second counters 122, 124 in the system 100 above, such counters 122, 124 may be located elsewhere (e.g., in the processor 102). Further, although the processor 102 includes the third counter 126 in the system 100 above, such counter 126 may be located elsewhere (e.g., in the translation chip 106).

Accordingly, while the present invention has been disclosed in connection with exemplary embodiments thereof, it should be understood that other embodiments may fall within the spirit and scope of the invention, as defined by the following claims.

The invention claimed is:

1. A method of interfacing a processor and memory of a system, comprising:
providing a processor adapted to issue a command complying with a first protocol;
providing a memory coupled to the processor and accessible by a command complying with a second protocol; and
employing a plurality of scrub commands complying with the second protocol to check respective portions of the memory for errors, wherein each scrub command complying with the second protocol is a converted version of a scrub command complying with the first protocol issued by the processor and the respective portions are non-sequential, thereby refreshing bits stored in the entire memory within a predetermined time period.

2. The method of claim 1 further comprising:
employing the processor to issue a plurality of scrub commands complying with the first protocol; and
converting the plurality of scrub commands complying with the first protocol to the plurality of scrub commands complying with the second protocol, respectively.

3. The method of claim 1 wherein employing the plurality of scrub commands complying with the second protocol to check respective portions of the memory for errors includes:
employing a first scrub command complying with the second protocol to read first bits from a first portion of the memory;
converting the first bits read from the memory to second bits that comply with the first protocol; and
employing the processor to check the second bits for errors.

4. The method of claim 3 further comprising:
if an error is detected in the second bits, employing the processor to correct the second bits;
converting the corrected second bits to comply with the second protocol; and
writing the converted corrected second bits back to the first portion of the memory.

5. The method of claim 3 wherein employing the plurality of scrub commands complying with the second protocol to check respective portions of the memory for errors further includes:
employing a second scrub command complying with the second protocol to read third bits from a second portion of the memory, wherein the first and second portions are non-sequential;
converting the third bits read from the memory to fourth bits that comply with the first protocol; and
employing the processor to check the fourth bits for errors.

6. The method of claim 5 further comprising:
if an error is detected in the fourth bits, employing the processor to correct the fourth bits;
converting the corrected fourth bits to comply with the second protocol; and
writing the converted corrected fourth bits back to the second portion of the memory.

7. The method of claim 1 wherein:
the first protocol is an extreme data rate protocol; and
the second protocol is a double data rate protocol.

8. An apparatus for interfacing a processor and memory of a computer system, comprising:
a processor adapted to issue a command complying with a first protocol; and
a translation chip adapted to couple to the processor and a memory accessible by a command complying with a second protocol;
wherein the apparatus is adapted to:
employ a plurality of scrub commands complying with the second protocol to check respective portions of the memory for errors, wherein each scrub command complying with the second protocol is a version of a scrub command complying with the first protocol issued by the processor that has been converted by the translation chip and the respective portions are non-sequential, thereby refreshing bits stored in the entire memory within a predetermined time period.

9. The apparatus of claim 8 wherein:
the processor is adapted to issue a plurality of scrub commands complying with the first protocol; and
the translation chip is adapted to convert the plurality of scrub commands complying with the first protocol to the plurality of scrub commands complying with the second protocol, respectively.

10. The apparatus of claim 8 wherein the apparatus is further adapted to:
employ a first scrub command complying with the second protocol to read first bits from a first portion of the memory;
employ the translation chip to convert the first bits read from the memory to second bits that comply with the first protocol; and
employ the processor to check the second bits for errors.

11. The apparatus of claim 10 wherein the apparatus is further adapted to:
if an error is detected in the second bits, employ the processor to correct the second bits;
employ the translation chip to convert the corrected second bits to comply with the second protocol; and
write the converted corrected second bits back to the first portion of the memory.

12. The apparatus of claim 10 wherein the apparatus is further adapted to:
employ a second scrub command complying with the second protocol to read third bits from a second portion of the memory, wherein the first and second portions are non-sequential;
employ the translation chip to convert the third bits read from the memory to fourth bits that comply with the first protocol; and
employ the processor to check the fourth bits for errors.

13. The apparatus of claim 12 wherein the apparatus is further adapted to:
if an error is detected in the fourth bits, employ the processor to correct the fourth bits;
employ the translation chip to convert the corrected fourth bits to comply with the second protocol; and
write the converted corrected fourth bits back to the second portion of the memory.

14. The apparatus of claim 9 wherein:
the first protocol is an extreme data rate protocol; and
the second protocol is a double data rate protocol.

15. A system for interfacing a processor and memory of a computer system, comprising:
a processor adapted to issue a command complying with a first protocol;
a memory accessible by a command complying with a second protocol; and
a translation chip adapted to couple to the processor and the memory;
wherein the system is adapted to:
employ a plurality of scrub commands complying with the second protocol to check respective portions of the memory for errors, wherein each scrub command complying with the second protocol is a version of a scrub command complying with the first protocol issued by the processor that has been converted by the translation chip and the respective portions are non-sequential, thereby refreshing bits stored in the entire memory within a predetermined time period.

16. The system of claim 15 wherein:
the processor is adapted to issue a plurality of scrub commands complying with the first protocol; and
the translation chip is adapted to convert the plurality of scrub commands complying with the first protocol to the plurality of scrub commands complying with the second protocol, respectively.

17. The system of claim 15 wherein the system is further adapted to:
employ a first scrub command complying with the second protocol to read first bits from a first portion of the memory;
employ the translation chip to convert the first bits read from the memory to second bits that comply with the first protocol; and
employ the processor to check the second bits for errors.

18. The system of claim 17 wherein the system is further adapted to:
if an error is detected in the second bits, employ the processor to correct the second bits;
employ the translation chip to convert the corrected second bits to comply with the second protocol; and
write the converted corrected second bits back to the first portion of the memory.

19. The system of claim 17 wherein the system is further adapted to:
employ a second scrub command complying with the second protocol to read third bits from a second portion of the memory, wherein the first and second portions are non-sequential;
employ the translation chip to convert the third bits read from the memory to fourth bits that comply with the first protocol; and
employ the processor to check the fourth bits for errors.

20. The system of claim 19 wherein the system is further adapted to:
if an error is detected in the fourth bits, employ the processor to correct the fourth bits;
employ the translation chip to convert the corrected fourth bits to comply with the second protocol; and
write the converted corrected fourth bits back to the second portion of the memory.

21. The system of claim 15 wherein:
the first protocol is an extreme data rate protocol; and
the second protocol is a double data rate protocol.
